(19) United States
(12) Patent Application Publication
(10) Pub. No.: US 2004/0075679 A1
(43) Pub. Date: Apr. 22, 2004

(54) Guest interface appliance

(76) Inventors: Kris O. Carter, Washington, DC (US); Phillip B. Usatine, Rockville, MD (US); Ram C. Singh, Alexandria, VA (US); William R. Burnett, Menlo Park, CA (US); Jenny Schlee, Mountain View, CA (US); Timothy Shey, Washington, DC (US); Sunil Doshi, Alexandria, VA (US)

Correspondence Address: COOLEY GODWARD LLP, ATTN: PATENT GROUP, 11951 FREEDOM DRIVE, SUITE 1700, ONE FREEDOM SQUARE- RESTON TOWN CENTER, RESTON, VA, 20190-5061, US

(21) Appl. No.: 10/418,309

(22) Filed: Apr. 18, 2003

Related U.S. Application Data
(60) Provisional application No. 60/375,582, filed on Apr. 25, 2002.

(51) Int. Cl. G09G 5/00

(52) U.S. Cl. 345/733

(57) ABSTRACT

The present invention provides a guest service delivery system that includes a user interface control. The guest service delivery system further includes a display configured to present a user interface that enables access to a guest service, wherein the user interface is configured to receive input through physical interaction by a user with the user interface control.

### CROSS-REFERENCE TO RELATED APPLICATION

This application claims priority to U.S. Provisional Patent Application Serial No. 60/373,582, filed Apr. 19, 2002, entitled “Guest Interface Appliance,” Attorney Docket No. ESTX-001/00US, the disclosure of which is incorporated herein by reference in its entirety.

### BACKGROUND

This invention relates generally to service delivery in a guest facility, and more particularly to a service and interface apparatus that enables a guest to select and initiate the delivery of guest services.

In the hotel industry, rooms are typically configured to provide a variety of guest services. For example, guests are typically provided with a set of services that include pay-per-view TV, concierge, and an in-room food service. The effectiveness in delivering these services will greatly impact a guest's perception of the quality of the hotel itself. To ensure consistency in future streams of income, hotels and other guest facilities must constantly reevaluate the quality of their own service offerings.

In conventional industry arrangements, the various service offerings are often delivered through a variety of means. For example, a guest facility may be configured to deliver a pay-per-view TV service through a remote-controlled TV user interface, deliver a concierge or information service through a physical representative stationed in the guest facility lobby, and deliver an in-room food service through a live or automated telephone answering service. In this example, the disparate methods of delivering the various services are often inefficient in that the guest is typically unable to leverage the spectrum of services in a consistent manner. Whether through lack of knowledge or inconvenience, a poorly leveraged service framework cannot enhance the reputation of the associated guest facility. Accordingly, what is needed is a mechanism that improves the delivery of various services within a guest facility.

### SUMMARY

The present invention provides a guest service delivery system that includes a user interface control. The guest service delivery system further includes a display configured to present a user interface that enables access to a guest service, wherein the user interface is configured to receive input through physical interaction by a user with the user interface control.

### BRIEF DESCRIPTION OF THE DRAWINGS

FIG. 1 illustrates an embodiment of a guest interface appliance.

FIG. 2 illustrates an embodiment of a network infrastructure within a guest facility.

FIGS. 3A-3G illustrate an embodiment of a graphical user interface for a guest interface appliance.

FIG. 4 illustrates an embodiment of a guest service delivery system.

### DETAILED DESCRIPTION

An embodiment of the invention is discussed in detail below. While specific implementations are discussed, it should be understood that this is done for illustration purposes only. A person skilled in the relevant art will recognize that other components and configurations may be used without departing from the spirit and scope of the invention.

Visitors at various hotels and other guest facilities have become accustomed to a basic set of services, including a pay-per-view TV service, an in-person concierge service, and an in-room food service. This basic set of services has seen little innovation over the years. Conventionally, guest facilities have not placed great emphasis on designing an efficient platform for service delivery. Not surprisingly therefore, the limited scope of innovation has seen little success in providing a substantial improvement in the delivery of a broad spectrum of guest services. The term “guest facility” is used herein to represent any facility or structure in which a person can visit as a guest. Some examples of a guest facility include a hotel, a time share property, a cruise ship, and any kind of multi-dwelling unit complexes.

The present invention is generally directed to the improvement of guest-service delivery as a whole. In that regard, one of the goals of the present invention is to provide an efficient platform for access and delivery of guest services. It is believed that a unified vehicle of service access will not only improve the visibility of particular services, but also provide a framework for enabling the rapid roll-out and acceptance of new services within a guest-facility context.

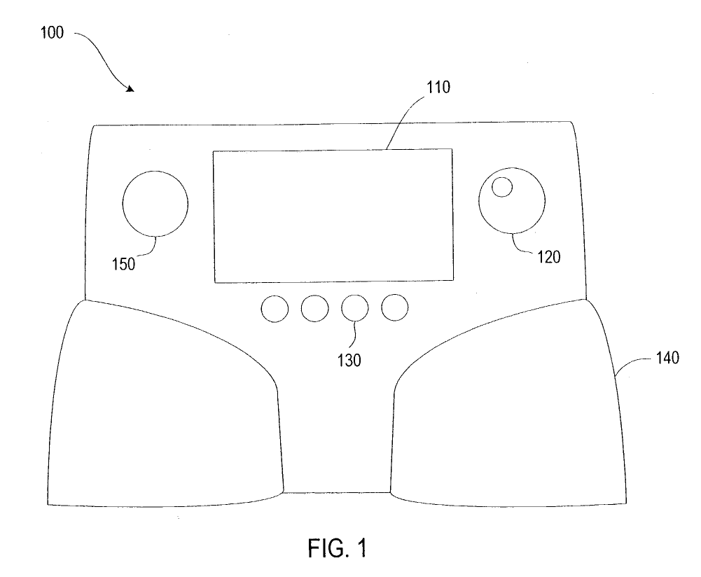

FIG. 1 illustrates an embodiment of a device that can be used to enhance the delivery of guest services, including a novel form of audio-on-demand service. As illustrated, the embodiment of FIG. 1 illustrates a guest interface appliance (GIA) 100 that can be located in individual guest rooms (e.g., on a desktop). In one embodiment, GIA 100 is representative of a two-way communication device that enables access to various guest services.

In the illustrated embodiment, GIA 100 includes a display 110, a scroll knob (or jog dial) 120, an input button 130, a speaker 140, and volume knob 150. As will be described in detail below, display 110 provides the guest (user) with an interface that enables the selection of and navigation within one of a variety of guest services. The term “guest service” can be referred to alternatively as a guest interaction service. There are several types of guest interaction services. Some examples of guest interaction services include guest information or informational services, guest transaction or commerce related services and guest communication services. In general, the interface framework can be used to access a variety of services, such as informational (e.g., account service, concierge, Internet access, two-way video conferencing, video e-mail), commerce related (e.g., shopping, in-room food service), communication (e.g. any type and/or form of hotel-to-guest communication, including communications such as meeting changes, room updates, schedule updates, etc.), multimedia entertainment (e.g., audio, video), or the like. As would be appreciated, various services such as two-way video conferencing and video e-mail may require additional peripheral devices such as a video camera that integrate with GIA 100. As GIA 100 can be designed to provide a framework for access to multiple guest services, the user can quickly identify the range of services that are available. Consultation of a bound hotel directory is therefore unnecessary.

Interaction with GIA 100 can be enabled through interaction with user interface controls such as scroll knob 120 and input button 130. Scroll knob 120 and input button 130 can be used to select among various interface-enabled options that are presented on display 110.

In one embodiment, the scroll knob 120 may be used to scroll through any type of information, such as information relating to various services, that is presented on display 110. For example, when the GIA 100 is used in connection with providing multimedia entertainment, the user can manipulate the scroll knob 120 to scroll through available multimedia content, such as album titles or song titles, from which the user can make a selection.

In various embodiments, the user can scroll through information using the scroll knob 120 at a constant rate or at a variable rate. In one embodiment, the scroll knob 120 may have an acceleration functionality associated therewith. The acceleration functionality varies the scrolling through information based on the user's manipulation of the scroll knob 120.

In one embodiment, the rate at which displayed information advances is based on the speed at which the user rotates the scroll knob 120. The amount of rotation of the scroll knob 120 has a non-linear relationship with the speed at which information advances on the display 110. In other words, the advancement through the displayed or on-screen information when the scroll knob 120 is rotated approximately 30° is not necessarily twice as much as the advancement when the scroll knob 120 is rotated approximately 15°.

In this embodiment, the advancement through the on-screen information is related to the rate of acceleration at which the user rotates the scroll knob 120. In one example, the user wants to advance through a listing of musical artists that is in alphabetical order. If the scroll knob 120 is turned approximately 30° at a first speed, such as 30° per second, then the on-screen information advances to a first point at which a first set of information is displayed, such as the first artist whose last name begins with the letter F. If the scroll knob 120 is turned approximately 30° at a second speed, such as 60° per second, then the on-screen information advances to a second point, such as artists with last names beginning with the letter N. Thus, a user may quickly scroll through a large amount of displayed data by turning the scroll knob 120 a short distance very quickly. In this example, the rotational acceleration with which the scroll knob 120 is turned has a linear relationship to the advancement through the information. It can be appreciated that the angles of rotation, the speeds of rotation and the end results (letters F and N) are intended to be exemplary of one implementation in accordance with the invention. Variations on the embodiment described above can be implemented.

Alternative relationships between the rotation of the scroll knob 120 and the speed at which information displayed on the GIA 100 is advanced can be implemented in various embodiments.

In one embodiment, interaction with GIA 100 can also be enabled through a touch screen that is overlaid on display 110. Inclusion of a touch screen device on GIA 100 will enable the user to interact with GIA 100 in a direct and intuitive manner. As would be appreciated, interaction with a graphical user interface that is presented on display 110 can be facilitated through a variety of user interface controls, or combinations thereof. The particular types of user interface controls that are selected for a particular GIA 100 are naturally dependent on the type of appliance, the type of service, and the menu of services available.

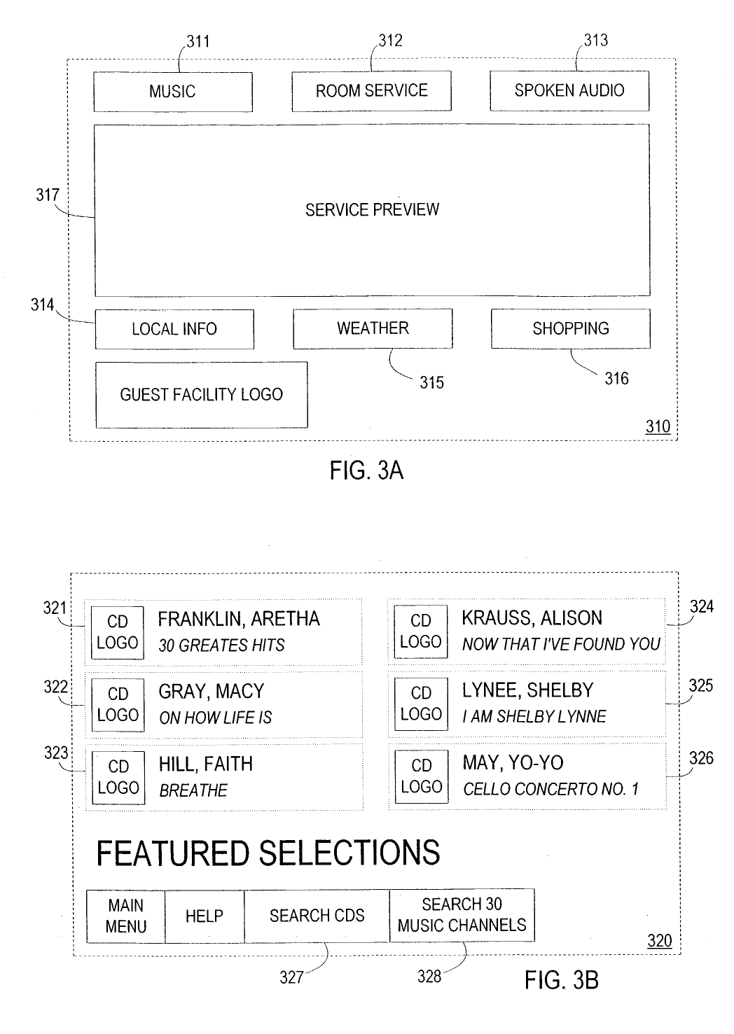

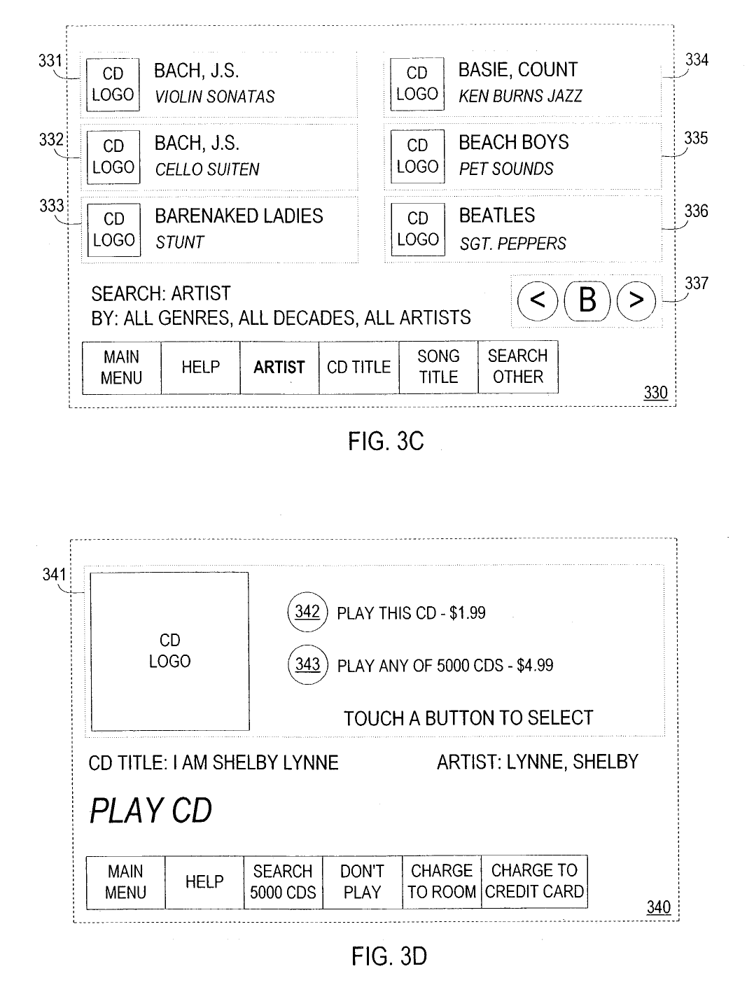

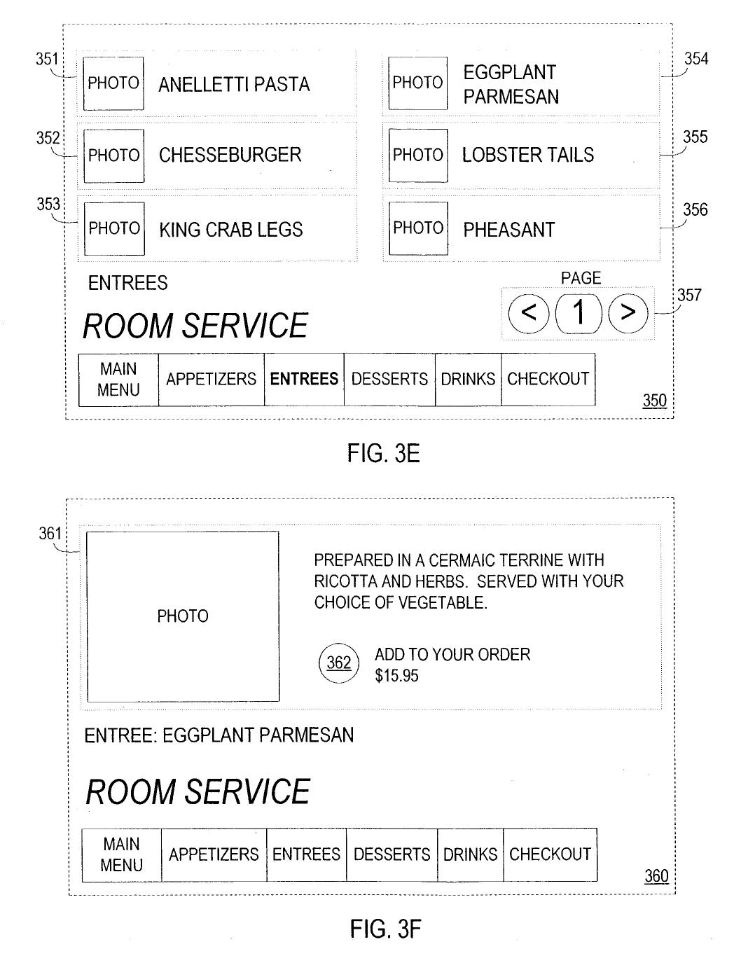

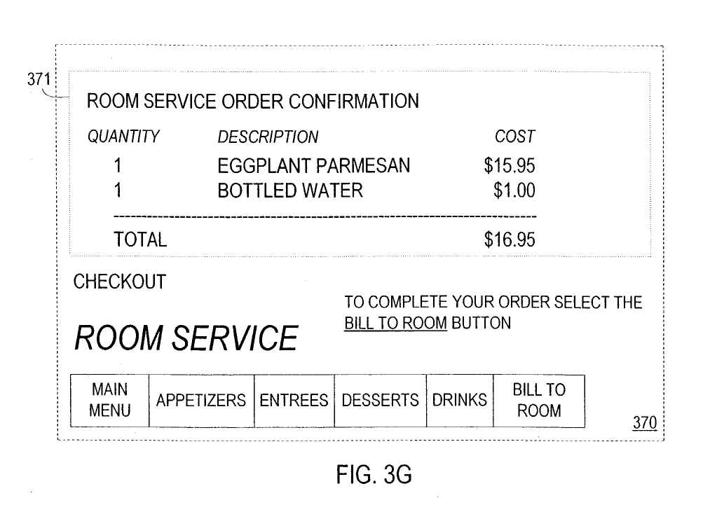

As further illustrated in the embodiment of FIG. 1, GIA 100 also includes a set of speakers 140. In an alternative embodiment, speakers 140 are not integrated within GIA 100. Rather, speakers 140 are external to GIA 100 and driven by GIA 100 through a wired or wireless connection. Speakers 140 can be used in the delivery of a guest service that includes an audio component, such as an audio-on-demand service. This audio-on-demand service will be described in detail below with reference to the interface screens of FIGS. 3A-3D, which illustrate an interface for selection of audio content.

As noted, GIA 100 can be provisioned within an individual guest room of a multi-room guest facility. In one embodiment, the plurality of GIAs 100 can communicate with one or more application servers that are configured to deliver one or more guest services to users at GIAs 100.

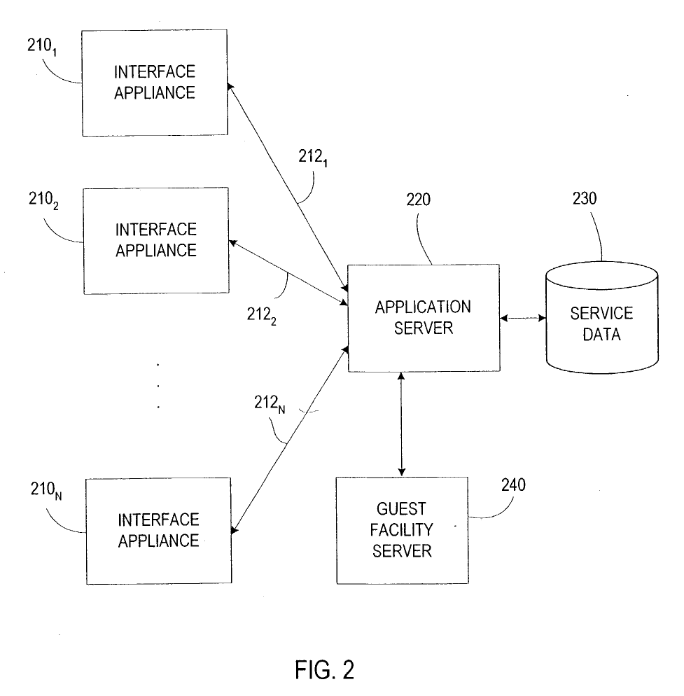

FIG. 2 illustrates an embodiment of a network of GIAs 210₁-210_{N} within a multi-room guest facility. In the illustrated embodiment, GIAs 210₁-210_{N} communicate with an application server 220 over respective connections 212₁-212_{N}. In general, application server 220 can represent one or more servers, each of which may be configured to control the delivery of one or more guest services.

In various embodiments, connections 212₁-212_{N} can be physically embodied as a wired or wireless connection (e.g., Bluetooth, 802.11, or the like). As would be appreciated, the specific form of connections 212₁-212_{N} may be dependent on the existing infrastructure within the multi-room guest facility.

In one embodiment, GIAs 210₁-210_{N} are configured to operate as thin, stateless clients. In general, a thin client has limited local resources in terms of hardware and software. The thin client functionally requires processing time, applications and services to be provided from a centralized server. In an alternative embodiment, GIAs 210₁-210_{N} are configured to operate as thick clients. In general, a thick client is functionally rich in terms of hardware and software. Thick clients are capable of storing and executing their own applications as well as network-centric applications. As would be appreciated, the embodiment of GIAs 210₁-210_{N} as thick or thin clients is dependent on implementation issues such as cost, functionality, and complexity of the service delivery framework in the guest facility.

In one embodiment, GIAs 210₁-210_{N} are configured to communicate with application server 220 via industry standard protocols and technologies. For example, GIAs 210₁-210_{N} can be configured to leverage protocols and technologies such as TCP/IP, HTTP/HTTPS, HTML, Dynamic HTML, Java, XML, Macromedia Flash, or the like, to deliver an intuitive user interface to the various guests. In general, the leveraging of browser-based technologies on the client ensures that the software will not be tied to any specific hardware configuration or operating system. This framework simplifies the provisioning, operability, and maintenance of the GIA network that is distributed within a multi-room guest facility.

As further illustrated in FIG. 2, application server 220 communicates with service database 230 and guest facility server 240. In general, service database 230 can represent a database that is owned and operated by a service provider, who has provisioned and maintained a service offering within the guest facility. The service database 230 can be configured to store any type of service content that a guest at GIA 210ᵢ would desire to retrieve.

In one example, service database 230 can be configured to store audio data files that are to be used in the delivery of an audio-on-demand service to GIAs 210₁-120_{N}. As will be described in detail below with respect to the user interface screens of FIGS. 3A-3D, the audio delivery service can be enabled and delivered through a GIA interface that promotes the rapid identification and selection of audio content that is stored in service database 230.

In one embodiment, service database 230 can be configured to store audio files in a MP3 format. In other embodiments, service database 230 can be configured to store audio files in formats such as AU (G.711 mu-law), WAV (N-bit PCM), WMA (windows media audio), RA (RealAudio), OGG (Ogg Vorbis), or the like. Proprietary storage formats could also be used. As would be appreciated, the concepts of the present invention are not dependent on the specific format of the audio data files.

Under the control of application server 220, audio data files are retrieved from service database 230 and transmitted (e.g., streamed) to a particular GIA 210ᵢ that has signaled to application server 220 a desire to retrieve a particular musical selection. In one embodiment, all audio data files are transmitted securely between GIA 210ᵢ and application server 220 over the guest facility's private network. This ensures the security of the audio data files and other proprietary data.

Returning to the illustrated embodiment of FIG. 2, application server 220 also communicates with guest facility server 240. In general, guest facility server 240 can represent a server that is owned and operated by the guest facility owner. This facility-owned server may be configured to store facility-controlled information that is collected by the facility owner. For example, the guest facility owner may collect personal information (e.g., name, address, credit card information, or the like) from its guests or store facility-originated information (e.g., in-room food service menus). In operation, application server 220, which may be under the control of an application provider, can communicate with guest facility server 240 to retrieve information that is necessary to provide services that are traditionally controlled by the guest facility owner.

To illustrate this scenario, consider the example of an in-room food service. Traditionally, an in-room food service is operated by the guest facility. In many situations, this in-room food service is motivated not by profit, but by the expectations that come with a service of convenience to the guests.

In-room orders are typically received over the phone by guest-facility personnel, then delivered to the guest-facility kitchen for fulfillment of the order. This process is costly both for the guests and the guest facility. Guests often have to live with the inefficiencies of the ordering process (e.g., busy signals and order inaccuracies), while the guest facility has to expend significant personnel resources in handling unpredictable levels of service demand. In many situations, the guest facility would desire to be relieved from the burden of the ordering process.

In the service delivery framework of FIG. 2, an application server 220 can be configured to handle the entire in-room food service ordering process. In this framework, browser-based order screens can be displayed on GIA 210 under the control of application server 220. These browser-based order screens would enable a guest to intuitively and accurately enter an order regardless of the levels of staffing that exist within the guest facility. Efficient and accurate orders would therefore result.

After an order is received by application server 220, the order can then be processed through interaction with guest facility server 240. In one embodiment, application server 220 can communicate with guest facility server 240 to authorize or record the transaction. For example, the cost of the order can be transmitted to guest facility server 240 for posting on a particular guest account. As would be appreciated, the division of responsibility between application server 220 and guest facility server 240 is implementation dependent. In one embodiment, the guest facility has placed the bulk of the responsibility on application server 220. For example, after an order is received, application server 220 can log the transaction. In another example, application server 220 can enable the printing of a room-service order directly to the guest-facility kitchen for post-order processing.

In general, the communication between application server 220 and guest facility server 240 enables an application provider to integrate, into one interface, a variety of services that would previously have been delivered to a guest through separate service interfaces. Thus, it is a feature of the present invention that a user interface, presentable by a GIA 210, can be used as a singular interface point for the delivery of guest services. By providing a singular interface point, guests will always know where to turn for satisfaction of a need that arises during a stay. Regardless of whether their need is of an entertainment or informational nature, GIA 210ᵢ will be looked upon as the single source for guest services. Significantly, a guest will find over time that interaction with GIA 210ᵢ will enable a guest to understand to a greater degree the universe of services that are available. The inability to fulfill a guest's need is therefore expected to decline dramatically. If guests' needs are fulfilled consistently, satisfaction will inevitably follow.

To illustrate the synergy of a singular interface point, consider the example of a hotel that desires to provide a menu of services that include an audio service, an in-room food service, an information service, a weather service, and a shopping service. In this example, the singular interface point at GIA 210ᵢ would enable a guest to select between each of these service options using an interface screen that is presented on display 10.

FIG. 3A illustrates an embodiment of a service selection interface screen 310. Interface screen 310 includes selectable interface elements 311-316 that enable selection of a music service, a room service, a spoken audio service, a local information service, a weather service, and a shopping service, respectively. When a particular interface element 311-316 is highlighted but not selected, a preview of the service is displayed in service preview area 317.

In general, the music service enables a guest to select from a catalog of musical content to be delivered to speakers 140; the room service enables a guest to order from an on-line food menu; the spoken audio service enables a guest to select from a catalog of audio content including books, periodicals, newspapers, radio programs, speeches, or the like; the local information service enables a guest to retrieve information (e.g., restaurant guide, events, activities) about the community in which the guest facility is located; the weather service enables a guest to retrieve weather forecast information; and the shopping service enables a guest to view and purchase from an online catalog of services and products. To illustrate the use of a GIA in delivering a guest service, example interface screens for both the music service and the room service are described below.

When music interface element 311 is selected, the user is presented with interface screen 320, illustrated in FIG. 3B. Interface screen 320 includes a set of featured selections 321-326 that can be selected by the user. This set of featured selections 321-326 can be chosen to represent the CDs that are most likely to appeal to the average guest. In this manner, the guest can quickly select, without a catalog search, a recent popular release that may be of interest.

As an alternative to selection of a CD, the user can also select, via button 328, a genre-based music channel that offers a continuous play of musical content. This musical content can include a set of tracks that have been preselected from a variety of artists within a chosen genre (e.g., country, rock, blues, pop, jazz, classical). This continuous play of musical content enables a user to experience a range of content without relying on a particular CD selection.

If the user desires to search for a CD that is not displayed in the featured selections, the user can also search from the catalog of CDs using SEARCH CDS button 327. In general, the CD catalog can be searched in a variety of ways. For example, the CD catalog can be searched by artist, CD title, song title, genre, or decade of release. As would be appreciated, the CD catalog can also be searched using a combination of those search methods.

FIG. 3C illustrates an example search screen 330 that enables a user to search the CD catalog by artist. As further noted in search screen 330, the search has not been restricted by genre or decade of release. Search screen 330 includes a portion of a scrollable list of CD selections. This portion of the scrollable list includes six CD selections 331-336 that represent the first six CDs of the list of artists beginning with the letter “B”. The parameter of the alphabetical search is controlled by interface control 337. As illustrated in the menu portion of interface screen 330, the user can also select to search the CD catalog by CD title, song title, or other search mechanisms.

Once a display of musical selections 321-326, 331-336 is presented, the user can then select a particular selection of interest. FIG. 3D illustrates an example play CD screen 340 that can be shown if CD selection 325 of interface screen 320 is selected. Play CD screen 340 presents the user with two play options within interface portion 341. Specifically, the user can select a first option 342 that enables the user to listen to the selected Shelby Lynne CD. Alternatively, the user can select a second option 343 that enables the user to listen to any CD that is stored in the CD catalog. This full-ranging selection enables the user to listen to as much music as the user desires during his stay. Once one of selections 342 or 343 is made, the user can then choose to bill the amount to his room or to his credit card. After the billing phase is complete, the available audio selection can be retrieved from service database 230.

In one embodiment, an on-demand service, such as an on-demand audio service, may be provided in multiple stages or phases. The phases can be referred to alternatively as components. One type of on-demand audio service is an on-demand music service. In one embodiment, an on-demand audio service can have three phases: a passive or listening phase, an active or collection phase, and a purchasing phase.

In a passive phase of the service, a user can listen to an audio output, such as music, that is transmitted by the system. The listening is the passive phase of the user's experience with the service. The user may listen to music that the user has selected or that is provided automatically by the system.

In the active phase, a user may actively interact with the system. In one embodiment, the user may research or collect information related to and/or based on the audio outputs to which the user listened in the passive phase. For example, a user may seek more information regarding the music played. Alternatively, the user may seek other information, such as information related to the particular music genre, album information, artist information, biographical information, etc.

In the purchasing phase, the system facilitates the purchase by the user of particular content, such as an audio component, or services. In the on-demand music service, the user can purchase a particular album or other recording that the user listened to in the passive phase. The user may have obtained additional information in the active phase regarding the same product or service. It is contemplated that any type of audio recording or electronic file can be purchased by the user. Any type of purchasing software and/or interface that enables the user to purchase content or a service can be used.

In one on-demand music service implementation, a user may listen to a song that is played by the system. If the user wishes to obtain additional information relating to that song, the user can access such information in the active phase. If the user wants to purchase the album or other recording that includes the song, the user can purchase the album or recording in the purchasing phase by providing the relevant information.

Although the three phase paradigm is described above with reference to an on-demand music service, such a paradigm can be employed in connection with a variety of services. Appropriate services include those suitable for providing passive information (e.g., samples or advertisements), allowing a user to obtain more information on a desired service or product, and facilitating the purchase by a user of services and/or products.

Having described example interface screens for an on-demand music service, example interface screens for a room service are now described. In general, a room service can be enabled through the presentation of various categories of food items. In a conventional offering, the room service can present categories including appetizers, entrees, desserts, and drinks.

FIG. 3E illustrates an embodiment of an entree screen 350 for the room service. Entree screen 350 includes a portion of a list of entree selections. This portion of the list includes six entree selections 351-356 that represent the first page of entree selections. Further pages of entree selections can be viewed using interface control 357.

When an entree is selected, the user is then presented with selection screen 360, illustrated in FIG. 3F. Selection screen 360 includes a detailed description 361 of the selected entree. The user is then offered the opportunity to select the entree using selection option 362. If further items are desired, the user can then search for additional items from the categories of appetizers, entrees, desserts, and drinks as displayed on the room service menu.

After the user has completed his selection of food items, the user can then checkout using checkout screen 370, illustrated in FIG. 3G. Checkout screen 370 provides a summary 371 of the user's order along with an option of billing the order to the room.

As thus described, GIA 100, 210 can be used to access a wide variety of services through a common interface point. In one embodiment, the interface is a browser-based interface that is intuitively familiar to the majority of the guests. Access to services and the subsequent satisfaction will thereby be improved.

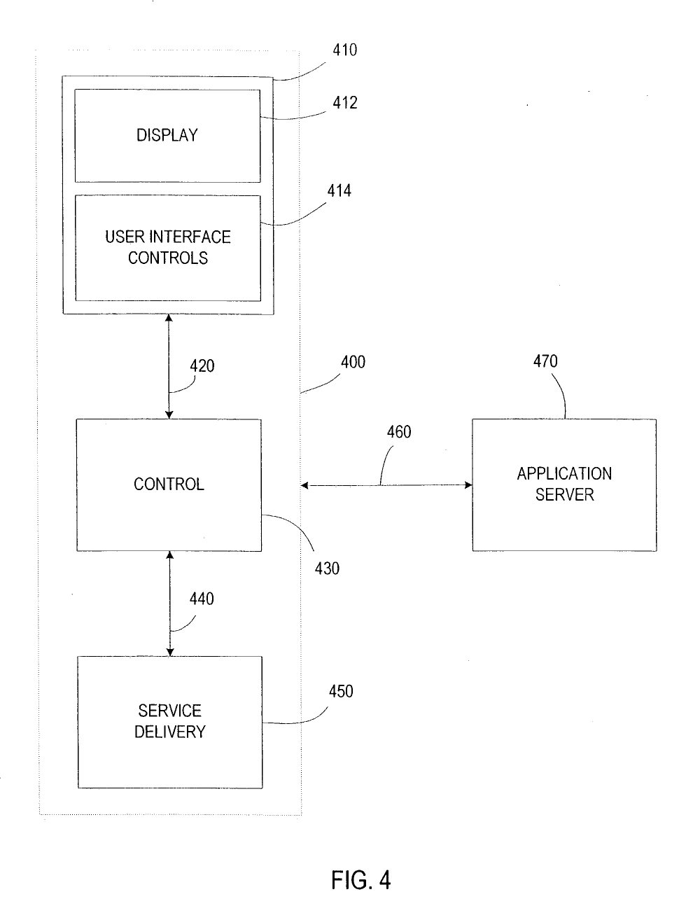

FIG. 4 illustrates a functional block diagram of a guest service delivery system. As illustrated, the guest service delivery system includes an interface and delivery system 400 that communicates with application server 470. Interface and delivery system 400 is generally operable to present an interface to a guest for selection of a service, forward an indication of that selection to application server 470, then receive information from application server 470 in delivering the selected service.

In the illustrated embodiment of FIG. 4, interface and delivery system 400 includes three functional components: an interface component 410, a control component 430, and a service delivery component 450.

Interface component 410 is primarily responsible for enabling interaction with the user and, in the illustrated embodiment, includes both display 412 and user interface controls 414. Display 412 enables the presentation of a graphical user interface, while user interface controls 414 enable the user to interact with the graphical user interface.

Control component 430 is primarily responsible for controlling and monitoring the operation of interface and delivery system 400. In general, the set of functions and responsibilities of control component 430 is implementation dependent. In one embodiment, control component 430 can be designed to coordinate the rendering of the graphical user interface on display 412, receive input that is received through user interface controls 414, and communicate with application server 470 in initiating and/or maintaining the delivery of a selected guest service.

Finally, service delivery component 450 is primarily responsible for presenting a selected service to a guest. As would be appreciated, service delivery component 450 can be embodied in various forms depending on the type of service being delivered. For example, if the service is an audio service, then service delivery component 450 can be embodied as a system including one or more audio speakers. In another example, if the service is a video service, then service delivery component 450 can be embodied as a system including a video screen and speakers. In yet another example, if the service is simply an informational service, then service delivery component 450 can be embodied as a system including a display screen.

It is a feature of the present invention that a variety of forms of service delivery component 450 can be coupled with a single interface component 410. This feature gives rise to a variety of embodiments in the physical and operational structure of interface and delivery system 400.

In one embodiment, interface component 410 is a handheld interface device that includes a display as well as one or more user interface controls such as a touch screen, scroll knobs, buttons, or the like. This handheld interface device can be integrated with control component 430 in varying degrees.

In one embodiment, the handheld interface device is physically coupled to control component 430. This physical coupling can be envisioned as a merging of components in a manner similar to a stand alone computing device. In one example, an LCD display and user interface controls (e.g., touch screen, keyboard, touch pad, or the like) are housed in a single device that also includes a microprocessor control. For example, an interface component and a control component can be combined into a device similar to a laptop computer, a tablet computer, a personal digital assistant, or the like.

In an alternative embodiment, the handheld interface device is physically decoupled from control component 430. Here, the handheld interface device communicates with control component 430 through connection 420. Connection 420 can be embodied as a wired or wireless connection, with the particular protocol being implementation dependent. In one example, the physical decoupling can be envisioned as a display device that presents an interface that is defined by a base computer device, an arrangement similar to a monitor and desktop computer. Here, a wireless connection 420 would be advantageous in that a guest can wield the display device in any part of the guest room without concern about the relative location of the base computer device. In general, this decoupling further enables an embodiment where the base computer device is situated outside of the room itself, thereby enabling the potential for a many-to-one configuration between display devices and a base computer device.

In combination, interface component 410 and control component 430 enable a guest to select a particular service that is being hosted by application server 470. The subsequent delivery of a selected service is then supported by service delivery component 450. Initially, it should be noted that service delivery component 450 need not be embodied as a distinct component. For example, if an information service (e.g., account service) has been selected, the account information can be displayed on the same display that presented the service selection interface. Thus, in this example, the service delivery component 450 is embodied as a portion of interface component 410.

More generally, however, service delivery component 450 can be embodied as a device (or collection of devices) that is entirely distinct from interface component 410. For example, in an audio-on-demand service, an audio selection can be streamed to a stereo-type device. Similarly, in a video-on-demand service, a video selection can be transmitted to a TV. As would be appreciated, control component 430 may be involved in the coordination of the delivery of a service to a particular service delivery component 450. Accordingly, control component 430 can communicate with service delivery component 450 via connection 440 as required.

In general, the decoupling of interface component 410 from service delivery component 450 can enable interface component to become a centralized portal into the spectrum of services that are supported by the guest facility. This framework is in contrast to conventional service delivery models. For example, in a conventional on-demand video service, a remote control is used to navigate a menu that is displayed on a TV screen. Once a selection is made on the TV-screen interface, the video selection is then displayed on the same TV screen. This coupling of interface and service delivery components results in a framework that is difficult to extend beyond the on-demand video service.

It should be noted that the framework illustrated in FIG. 4 supports a variety of embodiments based on distinct combinations of interface component 410, control component 430, and service delivery component 450. For example, each of interface component 410, control component 430, and service delivery component 450 can exist as distinct modules. In various embodiments, interface component 410 can be combined with control component 430, interface component 410 can be combined with service delivery component 450, and control component 430 can be combined with service delivery component 450. Additionally, interface component 410, control component 430, and service delivery component 450 can also be combined into a single delivery device such as that illustrated in the embodiment of FIG. 1.

It should be noted that the invention can extend beyond usage in a guest facility to be used as a multimedia content management and delivery system in the home and other contexts.

While the invention has been described in detail and with reference to specific embodiments thereof, it will be apparent to one skilled in the art that various changes and modifications can be made therein without departing from the spirit and scope thereof. Thus, it is intended that the present invention cover the modifications and variations of this invention provided they come within the scope of the appended claims and their equivalents.

What is claimed is:

1. A guest service delivery system, comprising:
a user interface control; and
a display physically coupled to said user interface control, said display being configured to present a user interface that enables access to a multimedia service and a guest interaction service, said user interface being configured to receive input through physical interaction by a user with said user interface control, said received input being used to initiate delivery of a selected one of said multimedia service and said guest interaction service to said user.

2. The guest service delivery system of claim 1, wherein said user interface control is one of a touch screen, a scroll knob, a trackball, a track pad and an input key.

3. The guest service delivery system of claim 1, further comprising:
a control element that is configured to communicate with an application server, wherein said application server delivers at least one of said multimedia service and said guest interaction service.

4. The guest service delivery system of claim 3, wherein said control element is part of a single device that also includes said user interface control and said display.

5. The guest service delivery system of claim 3, wherein said user interface control and said display are part of a first device, and said control element is part of a second device, said first device and said second device being physically separate.

6. The guest service delivery system of claim 3, wherein communication between said control element and said application server is based on an industry standard protocol.

7. The guest service delivery system of claim 3, wherein at the time of delivery of said selected one of said multimedia service and said guest interaction service to said user, said application server retrieves said selected one of said multimedia service and said guest interaction service.

8. The guest service delivery system of claim 3, wherein said user interface control, said display, and said control element are part of a first device that is physically separate from a second device that includes a multimedia service reception component, said multimedia service reception component being operative to receive a delivered multimedia service.

9. The guest service delivery system of claim 1, wherein a multimedia service is delivered to a multimedia service reception device.

10. The guest service delivery system of claim 9, wherein said multimedia service is one of an audio service and a video service.

11. The guest service delivery system of claim 9, wherein said multimedia service is streamed to said multimedia service reception device.

12. The guest service delivery system of claim 9, wherein said multimedia service reception device is part of a single device that also includes said user interface control and said display.

13. The guest service delivery system of claim 9, wherein said user interface control and said display are part of a first device, and said multimedia service reception device is part of a second device, said first device and said second device being physically separate.

14. The guest service delivery system of claim 1, wherein said guest interaction service is one of a guest information service, a guest transactional service and a guest communication service.

15. The guest service delivery system of claim 1, wherein said display is configured to present a user interface that enables management, control, selection and access to multimedia content.

16. The guest service delivery system of claim 1, wherein said display is configured to present a user interface that displays multimedia content information.

17. The guest service delivery system of claim 1, wherein said display is a first display, said system further comprising:
a video display, said first display being physically separate from video display, said first display being configured to present a user interface that both (i) displays information about video content and (ii) enables management, control, selection and access to said video content, said received input being used to initiate delivery of a selected item of video content.

18. A method of providing an on-demand music service, the method comprising:
providing multimedia content to a user, the multimedia content being from a preprogrammed series of multimedia content, and the multimedia content including a music component; and
enabling the user to select additional information relating to the music component on-demand.

19. The method of claim 18, wherein the music component includes a song and the additional information includes information relating to an album that includes the song.

20. The method of claim 19, further comprising:
enabling the user to listen, on-demand, to the entire album that includes the song.

21. The method of claim 19, further comprising:
enabling the user to listen, on-demand, to samples of songs from the album that includes the song.

22. The method of claim 18, further comprising:
enabling the user to purchase a musical recording including the music component.

23. A guest service delivery system, comprising:
a user interface control, said user interface control including a touch screen and a scroll knob; and
a display physically coupled to said user interface control, said display being configured to present a user interface that enables access to a multimedia service and a guest interaction service, said user interface being configured to receive input through physical interaction by a user with said user interface control, said received input being used to initiate delivery of a selected one of said multimedia service and said guest interaction service to said user, wherein said scroll knob is configured to cause information items to move from off said display onto said display for selection.

24. The guest service delivery system of claim 23, further comprising:
a control element that is configured to communicate with an application server, wherein said application server delivers at least one of said multimedia service and said guest interaction service.

25. The guest service delivery system of claim 24, wherein said control element is part of a single device that also includes said user interface control and said display.

26. The guest service delivery system of claim 24, wherein said user interface control and said display are part of a first device, and said control element is part of a second device, said first device and said second device being physically separate.

27. The guest service delivery system of claim 24, wherein communication between said control element and said application server is based on an industry standard protocol.

28. The guest service delivery system of claim 24, wherein at the time of delivery of said selected one of said multimedia service and said guest interaction service to said user, said application server retrieves said selected one of said multimedia service and said guest interaction service.

29. The guest service delivery system of claim 24, wherein said user interface control, said display, and said control element are part of a first device that is physically separate from a second device that includes a multimedia service reception component, said multimedia service reception component being operative to receive a delivered multimedia service.

30. The guest service delivery system of claim 23, wherein said guest interaction service is one of a guest information service, a guest transactional service, and a guest communication service.

31. The guest service delivery system of claim 23, wherein said display is configured to present a user interface that enables management, control, selection and access to multimedia content.

32. The guest service delivery system of claim 23, wherein said scroll knob has acceleration capabilities associated therewith, said acceleration capabilities causing displayed elements to advance on an accelerated basis depending on the speed with which said scroll knob is rotated.

33. The guest service delivery system of claim 32, wherein said displayed elements advance more quickly on said display when said scroll knob is rotated an amount at a first speed than when said scroll knob is rotated said amount at a second speed, said first speed being greater than said second speed.

34. An information delivery system, comprising:
a display, said display being configured to present a user interface that enables access to a service, said user interface being configured to receive an input, said received input being used to initiate delivery of said service; and
a user interface control, said user interface control including a scroll knob, said scroll knob being configured to cause information items to move from off said display onto said display for selection, said scroll knob including acceleration capabilities associated therewith, said acceleration capabilities causing displayed elements to advance on an accelerated basis depending on the speed with which said scroll knob is rotated.

35. The information delivery system of claim 34, wherein said displayed elements advance more quickly on said display when said scroll knob is rotated an amount at a first speed than when said scroll knob is rotated said amount at a second speed, said first speed being greater than said second speed.
